(19) United States
(12) Patent Application Publication
(10) Pub. No.: US 2005/0216388 A1
(43) Pub. Date: Sep. 29, 2005

(54) Tracking account structure to support different leverage levels within an investment fund

(76) Inventors: James C. Houghton, Belle Mead, NJ (US); Robert B. O'Connor, Rye, NY (US); James W. Barry, Dix Hills, NY (US); Paul Calderone, Woodcliff Lake, NJ (US); Craig Abruzzo, Brooklyn, NY (US)

Correspondence Address: KIRKPATRICK & LOCKHART NICHOLSON GRAHAM LLP, 535 SMITHFIELD STREET, PITTSBURGH, PA, 15222, US

(21) Appl. No.: 10/810,012

(22) Filed: Mar. 26, 2004

(51) Int. Cl. G06F 17/60

(52) U.S. Cl. 705/35; 705/37

(57) ABSTRACT

A method of supporting at least two different investor groups with different maximum leverage ratios in one investment fund is disclosed. Each different investor group may have an associated tracking account. According to various embodiments, the method includes establishing contractual arrangements between investors of the investor groups, the investment fund and an external lender. The contractual arrangements limit the recourse of the external lender to assets allocable to the investors of an investor group if the tracking account associated with such investor group triggers a margin call on a loan from the external lender. Alternatively, the contractual arrangements may limit the recourse of the external lender to assets allocable to the investors of an investor group if the trading account triggers a margin call to the extent that such call is allocable to such investor group. Loan proceeds from the external lender and contributions from each investor of the find are invested through a trading account associated with the investment fund. The method also includes calculating an allocation percentage of a trading account of the investment fund for each investor group to account for profits and losses of the trading account over the trading cycle based on the leverage ratio of each investor group.

### BACKGROUND

Various embodiments of the present invention are directed generally to methods and systems for establishing tracking accounts to support different leverage levels within an investment fund.

Investment fund managers, such as managers for hedge funds, generally apply leverage to some extent as part of their fund investment strategy. Different investor groups within a fund, however, may desire different risk/return profiles based on their investment objectives. Some investor groups may prefer a more conservative profile involving smaller amounts of leverage, while other investor groups may desire a more aggressive approach with higher leverage levels. If the underlying investment strategy of the fund is successful and appeals to a broad range of investors, it may be desirable to be able to cater to the differing risk/return profiles of the various investor groups.

Two main approaches to this problem exist today. First, the investor group seeking higher leverage levels may negotiate individually or as a group with an external lender to provide them loan proceeds secured by the investors' fund interest. These loan proceeds, along with the investors' capital, are then invested in the fund.

This approach can be quite costly to the investor. The lender typically requires a high interest rate to compensate them for the illiquidity of holding a hedge fund interest as collateral. Hedge funds typically have infrequent redemption intervals (usually monthly) and long notice requirements. In addition, the lender has only infrequent (if any) transparency into the underlying fund holdings. For this reason the few external lenders which provide this type of financing can charge high lending rates and can also require other restrictive terms, such as preferential liquidation rights, etc., which would need to be disclosed and approved by the other fund investors.

The second approach in existence today is for the fund manager to establish separate, new funds—one for each leverage level variant—and allocate investment activity to the separate funds. This approach requires the additional operational burden of managing and reporting on more funds and, in addition, requires that all trading activity be allocated between the separate funds. This approach could also require periodic rebalancing to ensure that the portfolios remain consistently composed. Especially for fund managers with a very active trading strategy (e.g., statistical arbitrage strategies), the additional burden of maintaining separate accounts can be quite great.

### SUMMARY

In one general aspect, embodiments of the present invention are directed to a method of supporting at least two different investor groups with different maximum leverage ratios in one investment fund. Each different investor group may have an associated tracking account. According to various embodiments, the method includes establishing contractual arrangements between the investors of the investor groups, the investment fund and an external lender. The contractual arrangements limit the recourse of the external lender to fund assets allocable to the investors of an investor group if the tracking account associated with such investor group triggers a margin call on a loan from the external lender. Loan proceeds from the external lender and contributions from each investor of the fund are invested by a trading account associated with the investment fund. The method also includes calculating an allocation percentage of the trading account for each investor group to account for profits and losses of the trading account over the trading cycle based on the leverage ratio of each investor group.

Consequently, embodiments of the present invention may eliminate the need for an investment fund to establish a separate fund to accommodate investor groups with different risk profiles. In addition, according to various implementations, the investment fund may be a hedge fund. Further, the end of the trading cycle may coincide with the end of the subscription/redemption cycle of the investment fund. Also, the external lender may be a prime broker for the investment fund. Thus, embodiments of the present invention may eliminate the need for the fund investors to search for additional external lenders, as the prime broker may provide all of the margin financing required by the fund, and can likely do so more economically, since the prime broker typically would not have similar illiquidity or transparency concerns.

In addition, according to various implementations, calculating the allocation percentage may comprise (i) determining an initial percentage allocation of the trading fund for each tracking account at the start of the trading cycle; (ii) apportioning profits and losses of the trading account over the trading cycle to each tracking account based on the initial percentage allocation; (iii) determining a revised contribution amount for each tracking account based on the apportioned profits and losses over the trading cycle; and (iv) calculating the allocation percentage of the trading account based on the revised contribution amounts for each tracking account. This last step may comprise, according to various embodiments, (i) for each tracking account, multiplying the revised contribution amount by the maximum leverage ratio for each tracking account to determine a leveraged contribution for each tracking account; (ii) summing the leveraged contribution for each tracking account; and (iii) for each tracking account, dividing the leverage contribution for the tracking account by the sum of the leveraged contributions for each tracking account.

In another general aspect, various embodiments of the present invention are directed to a method for determining an allocation percentage of at least two tracking accounts within one investment find. Each tracking account has a different maximum leverage ratio. The method may comprise receiving a contribution amount for each tracking account at the start of a trading cycle. Additionally, the method may include the step of calculating an allocation percentage of a trading account associated with the investment fund for each tracking account to account for profits and losses of the trading account over the trading cycle based on the leverage ratio of each tracking account and the contribution amount of each tracking account at the start of the trading cycle.

In yet another general aspect, various embodiments of the present invention are directed to a system for determining an allocation percentage of at least two tracking accounts within one investment fund. The system comprises an allocation determination module. The allocation determination module is for receiving a contribution amount for each tracking account at the start of a trading cycle, and calculating an allocation percentage of a trading account associated with the investment fund for each tracking account to account for profits and losses of the trading account over the trading cycle based on the leverage ratio of each tracking account and the contribution amount of each tracking account at the start of the trading cycle.

### DESCRIPTION OF THE FIGURES

Various embodiments of the present invention are described herein by way of example in conjunction with the following figures, wherein

FIG. 1 is a diagram of an investment fund with multiple tracking accounts;

FIG. 2 is a flowchart of a method of establishing the tracking accounts to support different leverage levels within the investment fund according to various embodiments of the present invention;

FIG. 3 is a diagram of an investment fund with two tracking accounts;

FIG. 4 is a flowchart of a method of determining the allocation percentage of each tracking account of the fund according to various embodiments of the present invention; and

FIG. 5 is a diagram of a system for determining the allocation percentage of each tracking account of the fund according to various embodiments of the present invention.

### DESCRIPTION

Various embodiments of the present invention are directed to methods and systems for establishing tracking accounts to support investor groups with different preferred maximum leverage levels within an investment fund. The investment fund may be any type of fund with an investment strategy and for which investor groups with different investment objectives may wish to invest, such as a hedge fund.

An external lender may lend funds to the investment fund which the investment fund may invest for the benefit of its investors. The external lender may assess the portfolio and investment strategy of the fund and, based thereon, provide the fund margin lending based on the comfort level of the external lender. The fund may invest the loan proceeds on behalf of its investors, although it need not invest at the maximum leverage level permitted by the lender.

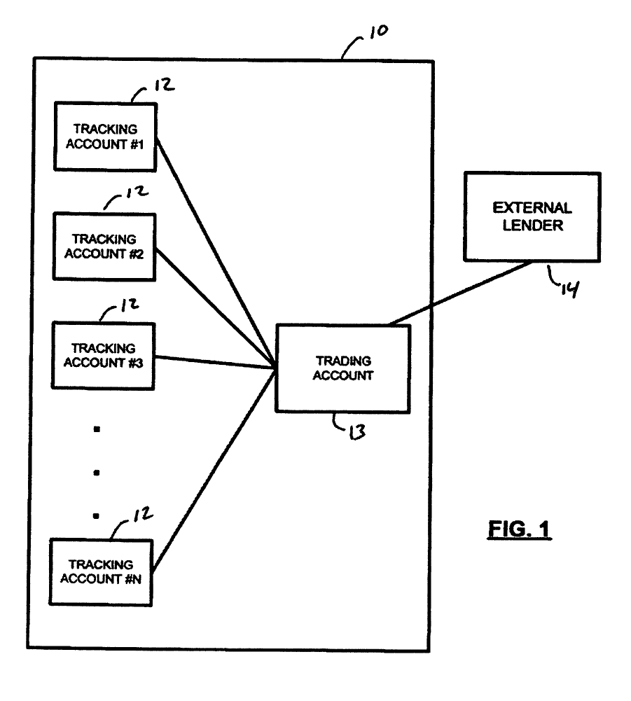

To accommodate investor groups with different preferred maximum leverage levels within one investment fund 10, the fund 10 may establish a separate tracking account 12 for each investor group, as shown in FIG. 1. A separate tracking account 12 may be established for each investor group having a different preferred maximum leverage level. There may be any number of tracking accounts 12. A trading account 13 associated with the fund 10 may invest on behalf of the investors of the various tracking accounts 12. The trading account may be, e.g., an account of the fund, an account of a separate trading entity in which the fund invests, or an account otherwise associated with the fund. The fund manager of the trading account 13 may invest according to the fund investment strategy, without having to maintain separate trading accounts for each tracking account 12.

For each different investor group, embodiments of the present invention comprise the establishment of contractual arrangements between the investors of the investor groups, the investment fund and the external lender 14. The contractual arrangements for each tracking group may comprise, for example, a number of contracts. According to one embodiment, the contractual arrangements may comprise two contracts—one contract between the investment fund, the external lender and/or the fund advisor, and a second contract between the investment fund and the investors of the particular tracking account. The contractual arrangements may provide that an investor group is liable to the external lender when the relevant tracking account goes on call. Alternatively, the contractual arrangements may provide that an investor group is liable to the external lender when the trading account goes on call to the extent that such call is allocable to such investor group. According to another embodiment, the contractual arrangement may comprise a single contract between the investment fund, the investors of the tracking account, the external lender, and/or the fund advisor. The contractual arrangement may limit the recourse of the external lender 14 to the fund assets allocable to a particular investor group if the tracking account associated with the investor group triggers a margin call on the loan from the external lender to the fund. In that way, the external lender may not seek recourse from assets related to investments made by other investor groups that do not have a margin call. For this reason, the contractual arrangement may be conceptualized as a so-called “ring-fencing” arrangement. The external lender 14 may be, for example, the prime broker for the fund 10. Consequently, the prime broker may provide all of the margin financing required for the fund 10, thereby eliminating the need for the investor groups to find other external lenders.

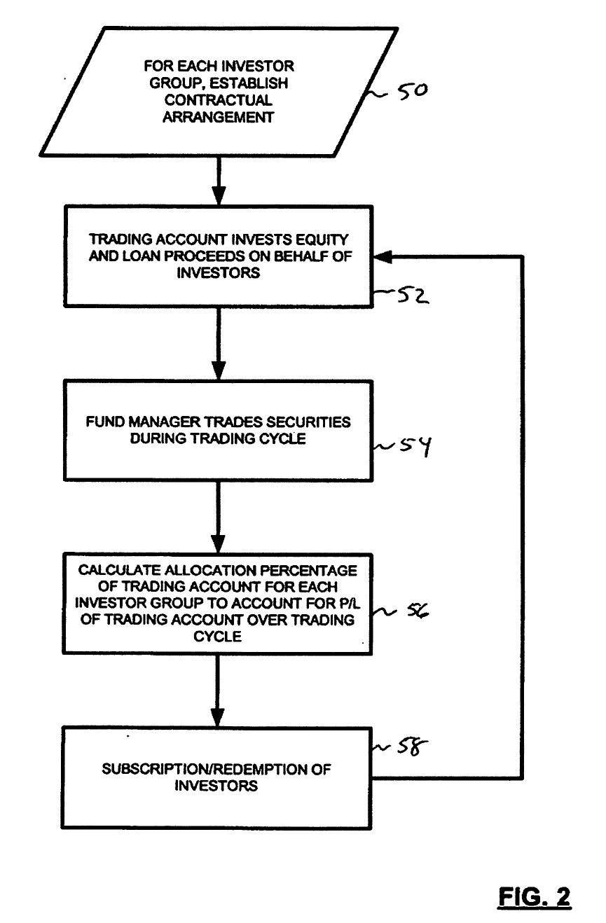

FIG. 2 is a flowchart of the method of establishing the tracking accounts 12 to support different leverage levels within an investment fund according to various embodiments of the present invention. At block 50, as explained above, the investors of the different investor groups, the investment fund, and the external lender may enter into the contractual arrangement(s) described above. At block 52, the equity contributions from the various fund investors as well as the proceeds from the loan from the external lender are invested through a trading account associated with the fund and, at block 54, with those contributions, the investment fund may invest and trade securities or other financial instruments on behalf of the fund investors during the trading cycle.

For each periodic trading time period (sometimes referred to herein as a “trading cycle” or “trading interval”) of the fund, at block 56, an allocation percentage of the trading account is calculated for each tracking account based on the leverage ratios of each tracking account. The end of the periodic trading time period may correspond, for the sake of convenience, to the subscription/redemption time periods for the fund, although the invention is not so limited. For example, hedge funds typically allow new investors to subscribe to the fund and existing investors to redeem their investment in the fund once a month. Thus, according to one embodiment, the trading cycle may be monthly and coincide with the subscription/redemption cycle of the fund.

At block 58, after the subscription/redemption cycle, the fund may take on new investors, belonging to one of the existing tracking accounts or belonging to a new tracking account with a different preferred maximum leverage level, and some investors may leave the fund. For a new tracking account, the contractual arrangement(s) between the investor group for the new tracking account, the fund and the external lender would have to be established. The cycle may then be repeated based on the contributions of the new investors.

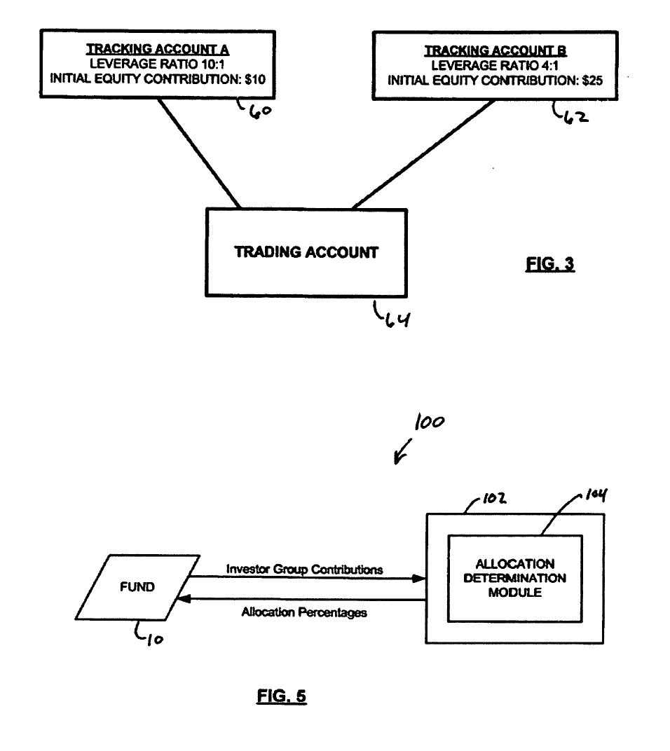

FIG. 3 is an example of how the structure may operate with two tracking accounts. The investors of tracking account A (60) may have a preferred maximum leverage ratio of 10 to 1 and the investors of tracking account B (62) may have a preferred maximum leverage ration of 4 to 1. Assume for the sake of this example that the initial equity contribution of the investors of tracking account A is $10 and the initial equity contribution of the investors of tracking account B is $25. Further assume for this example that the fund (or, e.g., a separate trading entity in which the fund invests) borrows enough from the external lender to satisfy the preferred maximum leverage ratio for each tracking account. In that case, $90 would be borrowed for the investors of tracking account A (to satisfy a 10:1 ratio) and $75 would be borrowed for the investors of tracking account B (to satisfy a 4:1 ratio). It should be noted that the fund (or, e.g., a separate trading entity in which the fund invests) may borrow from the external lender at less than the maximum leverage ratios established by the lender.

In this example, therefore, each tracking account would contribute $100 to the trading account 64. Thus, the total contribution would be $200. Assume that over the periodic trading time period the trading account 64 earns a profit of $10 on the $200 contribution, leaving the trading account with a total of $210 at the end of the trading cycle. A portion of the $210 would then be allocated to each tracking account based on their relative contribution levels.

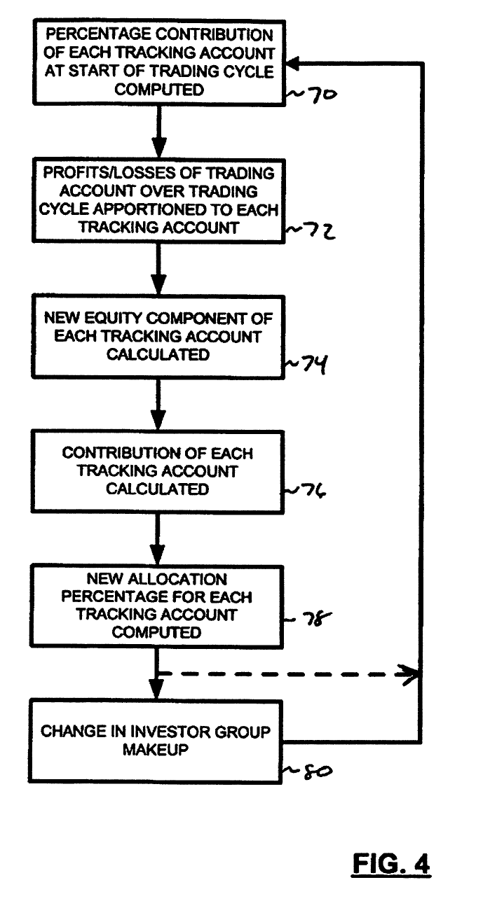

FIG. 4 is a flowchart of a process of calculating the allocation percentage of the tracking accounts according to various embodiments of the present invention. First, at block 70, the respective percentage contributions of each tracking account at the beginning of the trading time period is calculated. In this example, the percentage contribution is 50% as each tracking account contributed $100 of the total $200 contribution. Next, at block 72, profits or losses of the investment results over the trading interval are apportioned based on the percentage contribution of each tracking account at the beginning of the cycle. In this case, since the percentage contribution was 50% for each tracking account and the trading account made $10 in profits over the trading interval, $5 of the investment results would be allocated to each tracking account.

Next, at block 74, the new equity component for each tracking account is calculated based on the profits/losses of the trading account over the trading cycle, plus any additional equity contributions by the relevant investor group. In this example, assuming no additional equity contributions, the equity for tracking account A would be $15, computed as the $10 initial equity contribution plus the $5 from the allocated investment results from the trading account over the trading interval. The equity for tracking account B would be $30, computed as the $25 initial equity contribution plus the $5 from the allocated investment results.

Next, at block 76, the respective “leveraged” contribution for each tracking account is computed. In this example, the leveraged contribution for tracking account A would be $150, computed as $15 in equity (assuming no additional equity contributions) times 10 due to a leverage ratio of 10:1 for tracking account A (thus an additional $45 in leverage has been extended). The leveraged contribution for tracking account B would be $120, calculated as $30 (assuming no additional equity contributions) times 4 due to its 4:1 leverage ratio (thus an additional $15 in leverage has been extended). It should be noted that the maximum leverage ratio is used to determine each tracking account's allocation percentage of the trading account, even though the trading account may borrow at less than the maximum leverage level from the external lender. If the fund (or, e.g., a separate trading entity in which the fund invests) borrows at less than the maximum leverage level, the attributable contribution of each tracking account to the trading account is consistent with its allocation percentage.

At block 78, the new allocation percentage of the trading account funds is computed for each tracking account by determining their respective contributions to the trading account. This may be computed by dividing the leveraged contribution for each tracking account by the sum of the leveraged contributions for all of the tracking accounts. In this example, the sum of the leveraged contributions is $270 (computed as $150 for tracking account A plus $120 for tracking account B). As tracking account A would have contributed $150 of the $270 total, the new allocation percentage for tracking account A would be 150/270=55.6%. Conversely, the new allocation percentage of tracking account B would be 120/270=44.5%.

The new percentages could be used at block 70 in the calculation of the allocation percentage for the subsequent trading interval, assuming no change in investors. If there was a change in the investor makeup of the fund due to new subscribers or investors that redeemed their shares, at block 80, these percentages would need to be adjusted to account for the makeup of the new investor groups.

Now consider an example where the trading account 64 loses money during a trading period. For this example, assume the same initial equity contributions and leverage ratios for the tracking accounts as in the previous example, namely, tracking account A has an initial equity contribution of $10 with a leverage ratio of 10:1, and tracking account B has an initial equity contribution of $25 with a leverage ratio of 4:1. In this example, as before, the initial allocation percentage for each tracking account is 50% (block 70 of FIG. 4).

Further assume in this example that the trading account loses $10 during the trading period, i.e., the value of the fund declines by $10. In this case, the profits or losses of the investment results over the trading time period apportioned to each tracking account (block 72) would be −5$ since each tracking account is apportioned 50% of the $10 loss. Next, at block 74, assuming no additional equity is contributed by any investor groups, the new equity component for each tracking account would be $5 for tracking account A (computed as $10-$5) and $20 for tracking account B (computed as $25-$5).

Therefore, the respective leveraged contribution for each tracking account (block 76) would be $50 for tracking account A (computed as $5 equity times 10 for a 10:1 leverage ratio) and $80 for tracking account B (computed as $20 equity times 4 for a 4:1 leverage ratio). In calculating the new allocation percentage (block 78), the sum of the leveraged contributions for each tracking account in this example would be $130 (computed as $50 for tracking account A and $80 for tracking account B). The new allocation percentage for tracking account A would be $50/$130=38.5% and the new allocation percentage for tracking account B would be $80/$130=61.5%.

As can be seen in the above example where the trading account loses value, the leverage levels for certain of the tracking accounts may exceed the leverage levels (which may be specified in the contractual arrangement(s)) at which the external lender is willing to lend proceeds because the value of the equity of the tracking accounts may decline. For instance, in the above example, if the external lender was only willing to lend at a leverage ratio of 10:1 for the investor group of tracking account A, that investor group would have exceeded its 10:1 leverage ratio at some point in the trading cycle, because at the end of the trading cycle, its leverage ratio was 19:1 ($95 to $5 equity contribution). As a consequence, the investors of tracking group A may have exceeded their leverage limitations resulting (directly or indirectly) in a margin call by the external lender.

This situation may be handled in a variety of different ways. For example, in an embodiment where the investment fund permits intra-cycle reallocation, the process illustrated in FIG. 4 could be performed during the trading cycle when one of the tracking accounts is on call. The investors of the tracking account on call could then, for example, contribute new capital to get the allocations back to where they were at the beginning of the trading cycle. Alternatively, the reapportionment step (block 78) could be performed intra-cycle and the process could be repeated for the remainder of the cycle.

In another embodiment, the investors of the tracking account on call could contribute enough capital to satisfy their maximum leverage level without an intra-cycle reallocation. The reallocation would be performed at the close of the trading cycle, as shown in FIG. 4. An investment fund that chooses not to permit intra-cycle reallocation may prefer this rebalancing mechanism.

In another embodiment, the fund could liquidate enough of its portfolio, allocated to all tracking accounts, until the maximum leverage ratio of the external lender for the investors of the tracking account on call is satisfied. This approach would require pro rata partial liquidation of all tracking accounts, including tracking account not on call. Alternatively, liquidation could be performed only with respect to the assets allocable to the tracking account currently on call. In this case, the reapportionment step (block 78) would be performed intra-cycle once the liquidations had been completed.

In yet another embodiment, the fund could establish separate trading accounts for the different tracking accounts. This option, however, would result in two permanent accounts to which trading would be allocated. This would eliminate, going forward, the original benefits inherent with the structure described above, but would ensure that each investor class was dealt with independently.

It should be noted that, in this structure, there would be no “ring-fencing” of liabilities of the investors of the various tracking accounts unless proceeds are actually borrowed by the fund from an external lender, regardless of whether the maximum leverage level imposed by the external lender for any particular tracking account is exceeded or not.

FIG. 5 is a system 100 for computing the allocation percentages of the separate tracking accounts according to various embodiments of the present invention. The system 100 may comprise a computing device 102. The computing device 102 may include an allocation determination module 104 for computing the allocation percentages of the tracking accounts of the fund 10. The allocation determination module 104 may be implemented as software code to be executed by a processor(s) (not shown) of the computing device 102 using any type of computer instruction type suitable, such as, for example, Java, C, C++, Visual Basic, etc., using, for example, conventional or object-oriented techniques. The software code may be stored as a series of instructions or commands on a computer readable medium, such as a random access memory (RAM), a read only memory (ROM), a magnetic medium such as a hard drive or a floppy disk, or an optical medium such as a CD-ROM. The computing device 102 may be, for example, a server, a workstation, a personal computer, etc. In addition, although the computing device 102 is shown in FIG. 5 as a single unit, the functionality of the computing device 102 may be distributed across a number of networked computing devices.

The allocation determination module 104 may be in communication with the fund 10. For example, at the start of the trading cycle, the fund 10 may communicate the equity contributions of each investor group. The allocation determination module 104 may then compute the allocation percentages of the various tracking accounts pursuant to the process illustrated in FIG. 4. For each trading cycle, the allocation determination module 104 may communicate the reapportioned allocation percentages to the fund 10. The allocation determination module 104 may be administered by the external lender 14 (see FIG. 1), for example.

While several embodiments of the present invention have been described herein, it should be apparent that various modifications, alterations and adaptations to those embodiments may occur to persons skilled in the art. It is therefore intended to cover all such modifications, alterations and adaptations without departing from the scope and spirit of the present invention as defined by the appended claims.

1. A method of supporting at least two different investor groups with different maximum leverage ratios in one investment fund, wherein each investor group has an associated tracking account, the method comprising:
establishing one or more contractual arrangements between investors of the investor groups, the investment fund and an external lender, wherein the contractual arrangements limit the recourse of the external lender to fund assets allocable to investors of an investor group if the tracking account associated with the investor group triggers a margin call on a loan from the external lender, and wherein loan proceeds from the external lender and contributions from each investor of the fund are invested through a trading account associated with the investment fund; and
calculating an allocation percentage of the trading account for each investor group to account for profits and losses of the trading account over the trading cycle based on the leverage ratio of each investor group.

2. The method of claim 1, wherein the investment fund is a hedge fund.

3. The method of claim 1, wherein the end of the trading cycle coincides with the end of a subscription/redemption cycle of the investment fund.

4. The method of claim 1, wherein the external lender is a prime broker for the investment fund.

5. The method of claim 1, wherein calculating the allocation percentage comprises:
determining an initial percentage allocation of the trading fund for each tracking account at the start of the trading cycle;
apportioning profits and losses of the trading account over the trading cycle to each tracking account based on the initial percentage allocation;
determining a revised contribution amount for each tracking account based on the apportioned profits and losses; and
calculating the allocation percentage of the trading account based on the revised contribution amounts for each tracking account.

6. The method of claim 5, wherein calculating the allocation percentage of the trading account based on the revised contribution amounts for each tracking account comprises:
for each tracking account, multiplying the revised contribution amount by the maximum leverage ratio for each tracking account to determine a leveraged contribution for each tracking account;
summing the leveraged contribution for each tracking account; and
for each tracking account, dividing the leveraged contribution for the tracking account by the sum of the leveraged contributions for each tracking account.

7. The method of claim 6, further comprising, when one of the tracking accounts triggers a margin call from the external lender during the trading cycle, the investors of the tracking account on call contributing additional capital to the fund.

8. The method of claim 7, further comprising, calculating the allocation percentage of each tracking account intra-cycle, prior to the investors of the tracking account on call contributing additional capital to the fund.

9. The method of claim 6, further comprising, when one of the tracking accounts triggers a margin call from the external lender during the trading cycle, the fund liquidating assets from the trading account.

10. The method of claim 6, further comprising, when one of the tracking accounts triggers a margin call from the external lender during the trading cycle, calculating, prior to the end of the trading cycle, the allocation percentage of the trading account for each investor group.

11. A method for determining an allocation percentage of at least two tracking accounts within one investment fund, wherein each tracking account has a different maximum leverage ratio, comprising:
receiving a contribution amount for each tracking account at the start of a trading cycle; and
calculating an allocation percentage of a trading account for each tracking account to account for profits and losses of the trading account over the trading cycle based on the leverage ratio of each tracking account and the contribution amount of each tracking account at the start of the trading cycle.

12. The method of claim 11, wherein calculating the allocation percentage comprises:
determining an initial percentage allocation of the trading fund for each tracking account at the start of the trading cycle based on the contribution amount of each tracking account at the start of the trading cycle;
apportioning profits and losses of the trading account over the trading cycle to each tracking account based on the initial percentage allocation;
determining a revised contribution amount for each tracking account based on the apportioned profits and losses; and
calculating the allocation percentage of the trading account based on the revised contribution amounts for each tracking account.

13. The method of claim 12, wherein calculating the allocation percentage of the trading account based on the revised contribution amounts for each tracking account comprises:
for each tracking account, multiplying the revised contribution amount by the maximum leverage ratio for each tracking account to determine a leveraged contribution for each tracking account;
summing the leveraged contribution for each tracking account; and
for each tracking account, dividing the leveraged contribution for the tracking account by the sum of the leveraged contributions for each tracking account.

14. The method of claim 13, further comprising, when one of the tracking accounts triggers a margin call from an external lender during the trading cycle, the investors of the tracking account on call contributing additional capital to the fund.

15. The method of claim 14, further comprising, calculating the allocation percentage of each tracking account intra-cycle, prior to the investors of the tracking account on call contributing additional capital to the fund.

16. The method of claim 13, further comprising, when one of the tracking accounts triggers a margin call from an external lender during the trading cycle, the fund liquidating assets from the trading account.

17. The method of claim 13, further comprising, when one of the tracking accounts triggers a margin call from an external lender during the trading cycle, calculating, prior to the end of the trading cycle, the allocation percentage of the trading account for each investor group.

18. A system for determining an allocation percentage of at least two tracking accounts within one investment fund, wherein each tracking account has a different maximum leverage ratio, comprising an allocation determination module for:
receiving a contribution amount for each tracking account at the start of a trading cycle; and
calculating an allocation percentage of a trading account of the investment fund for each tracking account to account for profits and losses of the trading account over the trading cycle based on the leverage ratio of each tracking account and the contribution amount of each tracking account at the start of the trading cycle.

19. The system of claim 18, wherein the allocation determination module is further for calculating the allocation percentage by:
determining an initial percentage allocation of the trading fund for each tracking account at the start of the trading cycle based on the contribution amount of each tracking account at the start of the trading cycle;
apportioning profits and losses of the trading account over the trading cycle to each tracking account based on the initial percentage allocation;
determining a revised contribution amount for each tracking account based on the apportioned profits and losses; and
calculating the allocation percentage of the trading account based on the revised contribution amounts for each tracking account.

20. The system of claim 19, wherein allocation determination module is further for calculating the allocation percentage of the trading account based on the revised contribution amounts for each tracking account by:
for each tracking account, multiplying the revised contribution amount by the maximum leverage ratio for each tracking account to determine a leveraged contribution for each tracking account;
summing the leveraged contribution for each tracking account; and
for each tracking account, dividing the leveraged contribution for the tracking account by the sum of the leveraged contributions for each tracking account.

21. A method of supporting at least two different investor groups with different maximum leverage ratios in one investment fund, wherein each investor group has an associated tracking account, the method comprising:
establishing one or more contractual arrangements between investors of the investor groups, the investment fund and an external lender, wherein loan proceeds from the external lender and contributions from each investor of the fund are invested through a trading account associated with the investment fund, and wherein the contractual arrangements limit the recourse of the external lender to assets allocable to the investors of an investor group if the trading account triggers a margin call on a loan from the external lender and the margin call is allocable to the investor group; and
calculating an allocation percentage of the trading account for each investor group to account for profits and losses of the trading account over the trading cycle based on the leverage ratio of each investor group.

22. The method of claim 21, wherein calculating the allocation percentage comprises:
determining an initial percentage allocation of the trading fund for each tracking account at the start of the trading cycle;
apportioning profits and losses of the trading account over the trading cycle to each tracking account based on the initial percentage allocation;
determining a revised contribution amount for each tracking account based on the apportioned profits and losses; and
calculating the allocation percentage of the trading account based on the revised contribution amounts for each tracking account.

23. The method of claim 22, wherein calculating the allocation percentage of the trading account based on the revised contribution amounts for each tracking account comprises:
for each tracking account, multiplying the revised contribution amount by the maximum leverage ratio for each tracking account to determine a leveraged contribution for each tracking account;
summing the leveraged contribution for each tracking account; and
for each tracking account, dividing the leveraged contribution for the tracking account by the sum of the leveraged contributions for each tracking account.
